(19) United States
(12) Patent Application Publication
(10) Pub. No.: US 2024/0247819 A1
(43) Pub. Date: Jul. 25, 2024

(54) AIR CONDITIONING SYSTEM WITH THERMAL STORAGE

(71) Applicant: Energy Vault, Inc., Westlake Village, CA (US)

(72) Inventor: Andrea Pedretti, Thousand Oaks, CA (US)

(21) Appl. No.: 18/407,066

(22) Filed: Jan. 8, 2024

Related U.S. Application Data
(60) Provisional application No. 63/481,019, filed on Jan. 23, 2023.

(51) Int. Cl. F24F 5/00

(52) U.S. Cl. CPC F24F 5/0021

(57) ABSTRACT

An air conditioning (AC) system includes hot thermal storage and cold thermal storage.

The cold thermal storage of the AC system can be used to provide cooling (e.g., air conditioning) while consuming significantly less power (e.g., only consuming power to run a fan and a pump of the AC system). The hot thermal storage of the AC system can be used to preheat inlet water to a water heater or boiler, reducing the energy (e.g., consumption of electricity if an electric water heater, consumption of gas, if a gas water heater) needed for the water heater or boiler to provide hot water.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims priority to U.S. Provisional Patent Application No. 63/481,019 filed Jan. 23, 2023, the entirety of which is incorporated herein by references and is considered part of the specification.

### BACKGROUND

### Field

The present disclosure is directed to an air conditioning system, and more particularly to an air conditioning system with thermal storage (e.g., hot storage and/or cold storage).

### Description of the Related Art

Air conditioning is a necessity in warm climates, and its use is increasing due to longer heat waves. However, power consumption during heat waves increases significantly, greatly increasing the cost of electricity needed to run air conditioning systems.

### SUMMARY

In accordance with one aspect of the disclosure, an improved air conditioning (AC) system is provided that includes hot thermal storage and cold thermal storage. The cold thermal storage of the AC system can advantageously be used to provide cooling (e.g., air conditioning) while consuming significantly less power (e.g., only consuming power to run a fan and a pump of the AC system). The hot thermal storage of the AC system can be used to preheat inlet water to a water heater or boiler, thereby advantageously reducing the energy (e.g., consumption of electricity if an electric water heater, consumption of gas, if a gas water heater) needed for the water heater or boiler to provide hot water.

In accordance with another aspect of the disclosure, an air conditioning system is provided. An example air conditioning system includes a hot thermal storage unit having a vessel that holds a volume of a thermal transfer material (e.g., wax), and a conduit that extends through the thermal transfer material. The conduit is configured to receive therethrough a compressed refrigerant in gas form that condenses and transfers heat to the thermal transfer material. The air conditioning system also includes a cold thermal storage unit having a second vessel that holds a volume of a second thermal transfer material, and a second conduit that extends through the second thermal transfer material. The second conduit is configured to receive therethrough an expanded refrigerant in gas form that absorbs heat from the second thermal transfer material.

In accordance with another aspect of the disclosure, the air conditioning system includes a compressor fluidly connected to and interposed between the cold thermal storage unit and the hot thermal storage unit. A heat exchanger for ambient heat rejection can be fluidly connected to and disposed downstream of the hot thermal storage unit along with a throttling valve fluidly connected to and disposed between the heat exchanger and the cold thermal storage unit. In one example, the compressor is configured to increase a pressure and a temperature of the expanded refrigerant exiting the cold thermal storage unit to form the compressed refrigerant. The compressed refrigerant is configured to fully charge the thermal transfer material. In another example, a third conduit is configured to extend into the thermal transfer material, the third conduit extending to a water heater, the thermal transfer material configured to heat a liquid flowing through the third conduit. The hot thermal storage unit is configured to continue heating the liquid when the air conditioning system is turned off and to preheat water directed to a water inlet of a water heater.

In some aspects of the disclosure, the cold thermal storage unit is operatively connected to a second cooling loop including a fourth conduit that extends through the second vessel, a heat exchanger, a fan operable to flow air past the heat exchanger, and a pump to pump a refrigerant through the fourth conduit. The second thermal transfer material (e.g., ice) cools the refrigerant flowing through the fourth conduit and the cooled refrigerant flows through the heat exchanger and produces a cooling air that is blown past the heat exchanger by the fan. The second cooling loop is configured to continue producing a cooling air when the air conditioning system is turned off. In some examples, the air conditioning system includes a second cold thermal transfer unit including a third vessel that holds a volume of a third thermal transfer material, and a third conduit that extends through the third thermal transfer material the conduit configured to receive therethrough the expanded refrigerant in gas form that absorbs heat from the third thermal transfer material.

In accordance with another aspect of the disclosure, an air conditioning system including one or more cold thermal storage units is provided. Each of the one or more cold storage units include a vessel that holds a volume of a thermal transfer material, and a conduit that extends through the thermal transfer material the conduit configured to receive therethrough an expanded refrigerant in gas form that absorbs heat from the thermal transfer material. In some examples, the one or more cold thermal storage units include multiple cold thermal storage units. In some examples, the air conditioning unit includes a hot thermal storage unit including a vessel that holds a volume of a second thermal transfer material, and a conduit that extends through the second thermal transfer material. The conduit is configured to receive therethrough a compressed refrigerant in gas form that condenses and transfers heat to the second thermal transfer material. The hot thermal storage unit is configured to preheat water directed to a water inlet of a water heater. In some examples, a compressor is fluidly connected to and interposed between the one or more cold thermal storage units and the hot thermal storage unit. A heat exchanger for ambient heat rejection can be fluidly connected to and disposed downstream of the hot thermal storage unit. In some examples, a throttling valve is fluidly connected to and disposed between the heat exchanger and the one or more cold thermal storage units. The one or more cold thermal storage units are operatively connected to a second cooling loop including a third conduit that extends through the vessel, a heat exchanger, a fan operable to flow air past the heat exchanger, and a pump to pump a refrigerant through the third conduit, wherein the thermal transfer material cools the refrigerant flowing through the third conduit, said cooled refrigerant flowing through the heat exchanger and cooling air that is blown past the heat exchanger by the fan.

In accordance with another aspect of the disclosure, an air conditioning system including a hot thermal storage unit is provided. The hot thermal storage unit includes a vessel that holds a volume of a thermal transfer material (e.g., wax) and a conduit that extends through the thermal transfer material, the conduit configured to receive therethrough a compressed refrigerant in gas form that condenses and transfers heat to the thermal transfer material.

In accordance with another aspect of the disclosure, a method for operating an air conditioning system is provided. The method comprises flowing a compressed refrigerant in gas form through a hot thermal storage unit holding a volume of a thermal transfer material in a vessel via a conduit extending through the thermal transfer material to condense the refrigerant and transfer heat to the thermal transfer material. The method further includes flowing an expanded refrigerant in gas form through a cold thermal storage unit holding a volume of a second thermal transfer material in a second vessel via a second conduit extending through the second thermal transfer material to transfer heat from the second thermal transfer material to the expanded refrigerant. In some examples, the method includes flowing a liquid via a third conduit at least partially disposed in the thermal transfer material to heat the liquid from the thermal transfer material, the heated liquid directed to a water heater. Additionally, the method can include flowing a refrigerant through a second cooling loop that at least partially extends through the second thermal transfer material in the second vessel, where the second thermal transfer material cools the refrigerant flowing through the second cooling loop and directs the cooled refrigerant to a heat exchanger to cool air that is blown past the heat exchanger by a fan.

### BRIEF DESCRIPTION OF THE DRAWINGS

FIG. 1 is a schematic diagram of an air conditioning (AC) system with a hot thermal storage unit and a cold thermal storage unit.

FIG. 2A is a schematic diagram of the hot thermal storage unit of the AC system of FIG. 1.

FIG. 2B is a schematic perspective view of a water heater or boiler.

FIG. 3 is a schematic diagram of the cold thermal storage unit of the AC system of FIG. 1.

FIG. 4 is a schematic diagram of an air conditioning (AC) system with multiple cold thermal storage units.

### DETAILED DESCRIPTION

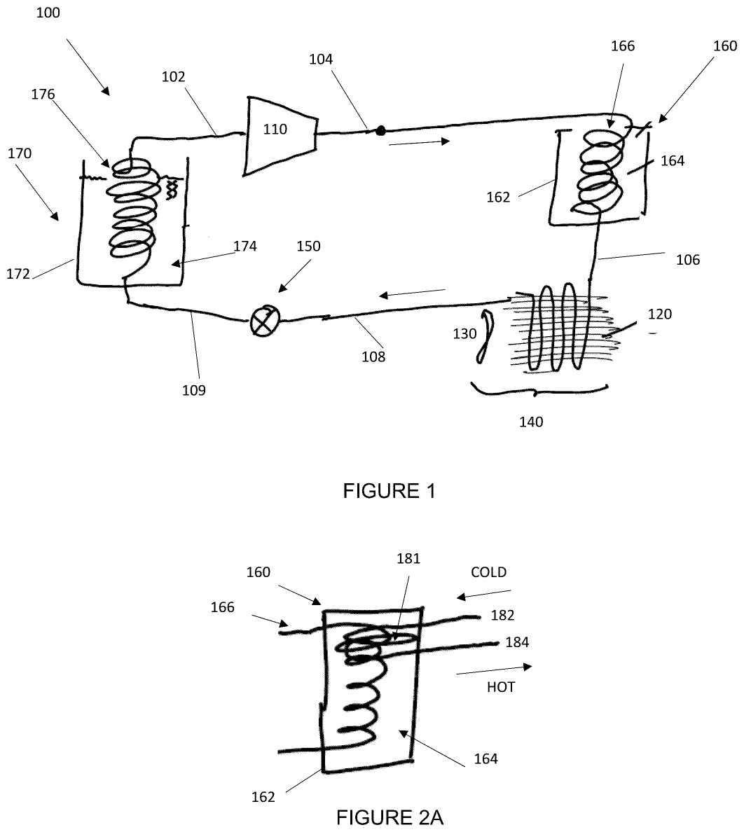

FIG. 1 shows an air conditioning (AC) system 100. The AC system 100 can be a residential or commercial system. The AC system 100 has a compressor 110, a heat exchanger 120 to reject heat to the atmosphere, an optional fan 130 operable to flow air over the heat exchanger 120, and a throttling valve 150. The throttling valve 150 is downstream of the heat exchanger 120 and connected to the heat exchanger 120 via conduit 108.

The AC system 100 also includes a hot thermal storage unit 160 downstream of the compressor 110 and disposed between the compressor 110 and the heat exchanger 120. The hot thermal storage unit 160 is connected to the compressor 110 via conduit (e.g., pipe, tube) 104. The heat exchanger 120 is downstream of the hot thermal storage unit 60 and connected to the hot thermal storage unit 160 via conduit 106.

The hot thermal storage unit 160 includes a vessel 162 that houses a volume of thermal transfer material or substance 164. In one implementation, the thermal transfer material 164 is a phase change material. In one example, the phase change material can be an organic material, for example wax. In another example, the phase change material can be molten salt. Other suitable phase change materials or thermal transfer materials or substances can be used. The hot thermal storage unit 160 can include a conduit 166 that extends through the thermal transfer material 164 in the vessel 162, heat transfer occurring between the thermal transfer material 164 and the conduit 166. Though not shown, in one implementation, the conduit 166 can have additional structure (e.g., fins, plates) to facilitate (e.g., improve, increase) heat transfer with the thermal transfer material 164.

The AC system 100 also includes a cold thermal storage unit 170 upstream of the compressor 110, downstream of the throttling valve 150 and disposed between the compressor 110 and the throttling valve 150. The cold thermal storage unit 170 is connected to the compressor 110 via conduit (e.g., pipe, tube) 102. The cold thermal storage unit 170 is connected to the throttling valve 150 via conduit 109.

The cold thermal storage unit 170 includes a vessel 172 that can receive and hold a volume of thermal transfer material or substance 174. In one implementation, the thermal transfer material 174 is a phase change material. In one example, the phase change material can be ice. In another example, the thermal transfer material 174 can be ice water. Other suitable phase change materials or thermal transfer materials or substances can be used. The cold thermal storage unit 170 can include a conduit 176 that extends through the thermal transfer material 174 in the vessel 172, heat transfer occurring between the thermal transfer material 174 and the conduit 176. Though not shown, in one implementation, the conduit 176 can have additional structure (e.g., fins, plates) to facilitate (e.g., improve, increase) heat transfer with the thermal transfer material 174.

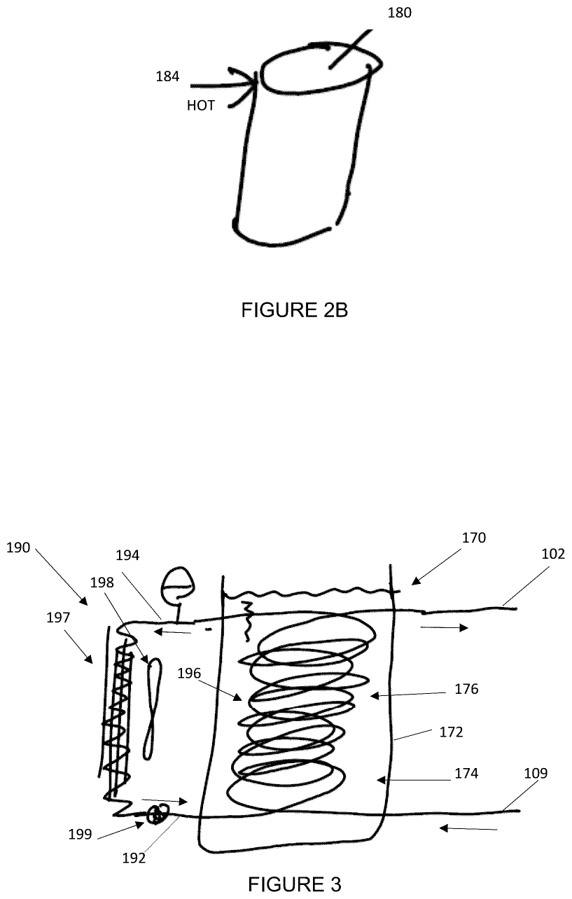

FIG. 2A shows one example of the hot thermal storage unit 160 of the AC system 100 in FIG. 1. A conduit 181 (e.g., tube, pipe) extends into the thermal transfer material 164 and has an inlet portion 182 and an outlet portion 184. A fluid (e.g. a liquid) can flow through the conduit 181 and can be heated by the thermal transfer material 164 via the wall of the conduit 81 (e.g., via conduction heat transfer). That is, the fluid can flow through the inlet portion 182 into the vessel 162 at a lower temperature, be heated by the thermal transfer material 164 in the vessel 162, and flow out of the vessel 162 via the outlet portion 184 at a temperature greater than that in the inlet portion 182. In one implementation, the fluid is water. In one implementation, the inlet portion 182 can extend to or connect to a water source, such as a municipal water source. In one implementation, the outlet portion 184 can extend to or connect to a water heater or boiler 180 (see FIG. 2B) that supplies hot water (e.g., to a residence, to a business). Advantageously, the hot thermal storage unit 160 preheats the water that is then delivered to the water heater or boiler 180, thereby advantageously reducing the energy consumption (e.g., of electricity if an electric water heater, of gas if a gas water heater) needed for the water heater or boiler 180 to provide hot water (e.g., to the residence, to the business).

FIG. 3 shows one example of a cold thermal storage unit 170 of the AC system 100 in FIG. 1. The cold thermal storage unit 170 can be larger (e.g., much larger, such as twice as large, three times as large) than the hot thermal storage unit 160. A flow loop 190 (e.g., secondary cooling loop) can include a conduit 196 (e.g., tube, pipe) that extends into the thermal transfer material 174 and has an inlet conduit portion 192 and an outlet conduit portion 194. A fluid (e.g., a liquid, such as Glycol) can flow through the flow loop 190 and can be cooled by the thermal transfer material 174 via the wall of the conduit 196 (e.g., the Glycol flowing through the conduit 96 can melt the ice used as the thermal transfer material 174). That is, the fluid can flow through the inlet conduit portion 192 into the vessel 172 at a higher temperature, be cooled by the thermal transfer material 174 in the vessel 172, and flow out of the vessel 172 via the outlet conduit portion 194 at a lower temperature than that in the inlet conduit portion 192. The flow loop 190 can include a heat exchanger 197 interposed between and fluidly connected to the inlet conduit portion 192 and outlet conduit portion 194, and a fan 198 operable to flow air relative to (e.g., past) the heat exchanger 197 (e.g., and into a room or space to deliver cooled or air conditioned air thereto). The flow loop 190 also includes a pump 199 that pumps the liquid (e.g., Glycol) through the conduit 196 in the vessel 172, outlet conduit portion 194, heat exchanger 197 and inlet conduit portion 192. Advantageously, the cold thermal storage unit 170 can cool the fluid (e.g., Glycol) in the flow loop 190 and thereby provide air conditioning to a room or space via the heat exchanger 197 even when the AC system 100 is off (e.g., when the compressor 110 is nor running), thereby reducing the energy consumption (e.g., of electricity) needed to provide air conditioning (e.g., during a time of peak power demand when electricity price is higher), or allowing air conditioning to be provided for an increased period of time for the same energy consumption amount. The AC system 100 can be operated as further discussed below. In another implementation, such as in commercial buildings or commercial applications, additionally or alternatively a flow loop through the cold thermal storage unit 170 can be implemented to deliver cold water (e.g., by circulating water through the cold thermal storage unit 170 to cool it).

In use, a refrigerant (e.g. Glycol) can run through the conduits 102, 104, 106, 108, 109, 166 and 176. The refrigerant can be in a gas phase in conduit 102 and enter the compressor 110 where it is compressed, increasing in pressure and temperature (e.g., to a temperature of between about 75° C. and 100° C.). The heated gas passes through the conduit 104 and enters the hot thermal storage unit 160, where the heated gas transfers heat to the thermal transfer material 164 or PCM and condenses. In one implementation, the condensation of the heated gas is able to fully charge (e.g., melt) the PCM 164 in the vessel 162, and the refrigerant (in liquid form) exits the hot thermal storage unit 160 via the conduit 106 at a lower temperature (e.g., at a temperature of between about 65° C. and 85° C., such as 65° C. to 80° C.). The liquid refrigerant then passes through the heat exchanger 120, where ambient heat rejection occurs (e.g., including heat rejection driven by a fan 130 blowing air past the heat exchanger 120) to further cool the refrigerant (e.g., to a temperature of about 40° C.). The liquid refrigerant flows through conduit 108 and past throttling valve 150, where the refrigerant expands into a gas a low pressure and low temperature. The refrigerant (in gas form) then enters the cold thermal storage unit 170 (via the conduit 176), where it absorbs heat from the thermal transfer material or substance 174 (e.g., ice water) to further cool the thermal transfer material 174 (e.g., make ice), and the gas exits the cold thermal storage unit 170 at higher temperature and then flows to the compressor 110 via the conduit 102 to perform the cycle again. Advantageously, the AC system 100 operates more efficiently than conventional AC systems since the heat transferred to the thermal transfer material or PCM 164 in the hot thermal storage unit 160 allows the heat rejection at the heat exchanger 120 to occur at a lower temperature, which increases the coefficient of performance (COP) of the AC system 100.

In operation, the AC system 100 can for example be operated at night (e.g., with grid power) when the cost of electricity is lower. In another example, the AC system 100 can be operated during the day (e.g., 6 am to 12 pm), for example using solar power (e.g., roof solar power units of a home) or when electricity cost is lower, to thereby charge the cold thermal storage unit 170 (e.g., make ice) and hot thermal storage unit 160 (e.g., melt the PCM). The AC system 100 can then be turned off, for example in the afternoon (e.g., 4-9 pm) when the cost of electricity is highest. The flow loop 190 can continue to operate (e.g., the fan 198 and pump 199 continue to run) to deliver air conditioning to a room or space, even while the AC system 100 is off because the compressor 110 is not being run. This allows continued cooling even in time periods when the cost of electricity is higher and power demand is higher, without powering the AC system 100 (e.g., except for powering the fan 198 and pump 199, which can be relatively low power components). Similarly, while the AC system 100 is off, the hot thermal storage unit 160 can continue to preheat water for the water heater or boiler 180, allowing the delivery of hot water (e.g., to the residence or business) while consuming less or no electricity (if an electric water heater) or less or no gas (if a gas water heater).

In one implementation, the AC system 100 can be a new system installed during new construction (e.g., of a home, of a commercial building). In another implementation, the AC system 100 can be installed in existing homes or commercial buildings (e.g. to replace prior AC systems). In one implementation, the hot thermal storage unit 160 can be a sealed vessel 162 that contains the thermal transfer material or PCM 164. The cold thermal storage unit 170 can be provided with the vessel 172 empty, allowing a user to fill it with water once installed and prior to operation of the AC system 100.

Though FIG. 1 shows the AC system 100 including the hot thermal storage unit 160 and the cold thermal storage unit 170, in some implementations, the AC system can exclude one of these thermal storage units. For example, in some implementations, the AC system only has a cold thermal storage unit and does not have a hot thermal storage unit. In another example, the AC system only has a hot thermal storage system and does not have a cold thermal storage system.

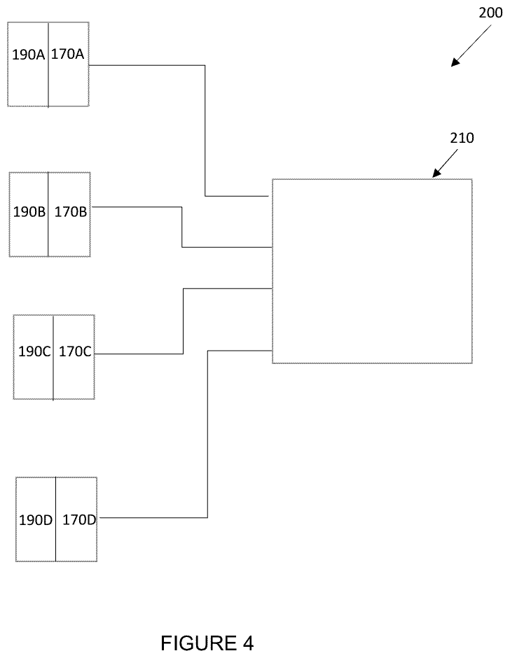

FIG. 4 shows a schematic view of an AC system 200. Some of the features of the AC system 200 are similar to features of the AC system 100 in FIGS. 1-3. Thus, reference numerals used to designate the various components of the AC system 200 are identical to those used for identifying the corresponding components of the AC system 100 in FIGS. 1-3, except that a letter has been added to the numerical identifier. Therefore, the structure and description for the various features of the AC system 100 and how it's operated and controlled in FIGS. 1-3 are understood to also apply to the corresponding features of the AC system 200 in FIG. 4, except as described below.

The AC system 200 differs from the AC system 100 in that it has multiple cold thermal storage units 170A, 170B, 170C, 170D disposed in separate locations (e.g., separate rooms of a residence, separate locations in a business, separate dwellings in a building with centralized AC). The multiple cold thermal storage units 170A, 170B, 170C, 170D can have the same structure and operate in a similar way as the cold thermal storage unit 170 in FIG. 3. Corresponding flow loops 190A, 190B, 190C, 190D can operatively connect to the cold thermal storage units 170A, 170B, 170C, 170D. Each of the flow loops 190A, 190B, 190C, 190D can have the same structure and operate in a similar way as the flow loop 190 in FIG. 3. The AC system 200 can have a centralized AC unit 210, which can include a compressor (similar to compressor 110), a condenser (e.g., a hot thermal storage like hot thermal storage unit 160), a heat exchanger for ambient heat rejection (similar to heat exchanger 120) and a throttling valve (e.g., similar to throttling valve 150 for expansion of the refrigerant into a gas).

### Additional Embodiments

In embodiments of the present disclosure, an air conditioning system and method may be in accordance with any of the following clauses:

Clause 1. An air conditioning system, comprising: a hot thermal storage unit including a vessel that holds a volume of a thermal transfer material, and a conduit that extends through the thermal transfer material, the conduit configured to receive therethrough a compressed refrigerant in gas form that condenses and transfers heat to the thermal transfer material; and a cold thermal storage unit including a second vessel that holds a volume of a second thermal transfer material, and a second conduit that extends through the second thermal transfer material, the second conduit configured to receive therethrough an expanded refrigerant in gas form that absorbs heat from the second thermal transfer material.

Clause 2. The system of Clause 1, further comprising a compressor fluidly connected to and interposed between the cold thermal storage unit and the hot thermal storage unit, a heat exchanger for ambient heat rejection fluidly connected to and disposed downstream of the hot thermal storage unit, and a throttling valve fluidly connected to and disposed between the heat exchanger and the cold thermal storage unit.

Clause 3. The system of Clause 2, wherein the compressor is configured to increase a pressure and a temperature of the expanded refrigerant exiting the cold thermal storage unit to form the compressed refrigerant, the compressed refrigerant is configured to fully charge the thermal transfer material.

Clause 4. The system of any preceding Clause, further comprising a third conduit configured to extend into the thermal transfer material, the third conduit extending to a water heater, the thermal transfer material configured to heat a liquid flowing through the third conduit.

Clause 5. The system of any preceding Clause, wherein the hot thermal storage unit is configured to continue heating the liquid when the air conditioning system is turned off.

Clause 6. The system of any preceding Clause, wherein the hot thermal storage unit is configured to preheat water directed to a water inlet of a water heater.

Clause 7. The system of any preceding Clause, wherein the thermal transfer material is wax.

Clause 8. The system of any preceding Clause, wherein the cold thermal storage unit is operatively connected to a second cooling loop comprising a fourth conduit that extends through the second vessel, a heat exchanger, a fan operable to flow air past the heat exchanger, and a pump to pump a refrigerant through the fourth conduit, wherein the second thermal transfer material cools the refrigerant flowing through the fourth conduit, the cooled refrigerant configured to flow through the heat exchanger and produce a cooling air that is blown past the heat exchanger by the fan.

Clause 9. The system of Clause 8, wherein the second cooling loop is configured to continue producing a cooling air when the air conditioning system is turned off.

Clause 10. The system of any preceding clause, further comprising a second cold thermal transfer unit including a third vessel that holds a volume of a third thermal transfer material, and a third conduit that extends through the third thermal transfer material the conduit configured to receive therethrough the expanded refrigerant in gas form that absorbs heat from the third thermal transfer material.

Clause 11. The system of any preceding clause, wherein the second thermal transfer material is ice.

Clause 12. An air conditioning system, comprising: one or more cold thermal storage units, each including a vessel that holds a volume of a thermal transfer material, and a conduit that extends through the thermal transfer material the conduit configured to receive therethrough an expanded refrigerant in gas form that absorbs heat from the thermal transfer material.

Clause 13. The system of Clause 12, further comprising a hot thermal storage unit including a vessel that holds a volume of a second thermal transfer material, and a conduit that extends through the second thermal transfer material, the conduit configured to receive therethrough a compressed refrigerant in gas form that condenses and transfers heat to the second thermal transfer material.

Clause 14. The system of Clause 13, further comprising a compressor fluidly connected to and interposed between the one or more cold thermal storage units and the hot thermal storage unit, a heat exchanger for ambient heat rejection fluidly connected to and disposed downstream of the hot thermal storage unit, and a throttling valve fluidly connected to and disposed between the heat exchanger and the one or more cold thermal storage units.

Clause 15. The system of any of Clauses 12-14, wherein the hot thermal storage unit is configured to preheat water directed to a water inlet of a water heater.

Clause 16. The system of any of Clauses 12-15, wherein the one or more cold thermal storage units are operatively connected to a second cooling loop comprising a third conduit that extends through the vessel, a heat exchanger, a fan operable to flow air past the heat exchanger, and a pump to pump a refrigerant through the third conduit, wherein the thermal transfer material cools the refrigerant flowing through the third conduit, said cooled refrigerant flowing through the heat exchanger and cooling air that is blown past the heat exchanger by the fan.

Clause 17. The system of any of Clauses 12-16, wherein the one or more cold thermal storage units includes multiple cold thermal storage units.

Clause 18. An air conditioning system, comprising: a hot thermal storage unit including a vessel that holds a volume of a thermal transfer material, and a conduit that extends through the thermal transfer material, the conduit configured to receive therethrough a compressed refrigerant in gas form that condenses and transfers heat to the thermal transfer material.

Clause 19. The system of Clause 18, further comprising one or more cold thermal storage units, each including a second vessel that holds a second volume of a second thermal transfer material and a second conduit that extends through the second thermal transfer material, the second conduit configured to receive therethrough an expanded refrigerant in gas form that absorbs heat from the second thermal transfer material.

Clause 20. The system of Clause 19, further comprising a compressor fluidly connected to and interposed between the one or more cold thermal storage units and the hot thermal storage unit, a heat exchanger for ambient heat rejection fluidly connected to and disposed downstream of the hot thermal storage unit, and a throttling valve fluidly connected to and disposed between the heat exchanger and the one or more cold thermal storage units.

Clause 21. The system of any of Clauses 18-20, further comprising a third conduit configured to extend into the thermal transfer material, the third conduit extending to a water heater, the thermal transfer material configured to heat a liquid flowing through the third conduit.

Clause 22. The system of Clause 21, wherein the hot thermal storage unit is configured to continue heating the liquid when the air conditioning system is turned off.

Clause 23. The system of any of Clauses 18-22, wherein the hot thermal storage unit is configured to preheat water directed to a water inlet of a water heater.

Clause 24. The system of any of Clauses 18-23, wherein the thermal transfer material is wax.

Clause 25. A method for operating an air conditioning system, comprising: flowing a compressed refrigerant in gas form through a hot thermal storage unit holding a volume of a thermal transfer material in a vessel via a conduit extending through the thermal transfer material to condense the refrigerant and transfer heat to the thermal transfer material; and flowing an expanded refrigerant in gas form through a cold thermal storage unit holding a volume of a second thermal transfer material in a second vessel via a second conduit extending through the second thermal transfer material to transfer heat from the second thermal transfer material to the expanded refrigerant.

Clause 26. The method of Clause 25, further comprising flowing a liquid via a third conduit at least partially disposed in the thermal transfer material to heat the liquid from the thermal transfer material, the heated liquid directed to a water heater.

Clause 27. The method of any of Clauses 25-26, further comprising flowing a refrigerant through a second cooling loop that at least partially extends through the second thermal transfer material in the second vessel, wherein the second thermal transfer material cools the refrigerant flowing through the second cooling loop and directs the cooled refrigerant to a heat exchanger to cool air that is blown past the heat exchanger by a fan.

While certain embodiments of the inventions have been described, these embodiments have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed devices.

What is claimed is:

1. An air conditioning system, comprising:
a hot thermal storage unit including a vessel that holds a volume of a thermal transfer material, and a conduit that extends through the thermal transfer material, the conduit configured to receive therethrough a compressed refrigerant in gas form that condenses and transfers heat to the thermal transfer material; and
a cold thermal storage unit including a second vessel that holds a volume of a second thermal transfer material, and a second conduit that extends through the second thermal transfer material, the second conduit configured to receive therethrough an expanded refrigerant in gas form that absorbs heat from the second thermal transfer material.

2. The system of claim 1, further comprising a compressor fluidly connected to and interposed between the cold thermal storage unit and the hot thermal storage unit, a heat exchanger for ambient heat rejection fluidly connected to and disposed downstream of the hot thermal storage unit, and a throttling valve fluidly connected to and disposed between the heat exchanger and the cold thermal storage unit.

3. The system of claim 2, wherein the compressor is configured to increase a pressure and a temperature of the expanded refrigerant exiting the cold thermal storage unit to form the compressed refrigerant, the compressed refrigerant is configured to fully charge the thermal transfer material.

4. The system of claim 1, further comprising a third conduit configured to extend into the thermal transfer material, the third conduit extending to a water heater, the thermal transfer material configured to heat a liquid flowing through the third conduit.

5. The system of claim 4, wherein the hot thermal storage unit is configured to continue heating the liquid when the air conditioning system is turned off.

6. The system of claim 1, wherein the hot thermal storage unit is configured to preheat water directed to a water inlet of a water heater.

7. The system of claim 1, wherein the thermal transfer material is wax.

8. The system of claim 1, wherein the cold thermal storage unit is operatively connected to a second cooling loop comprising a fourth conduit that extends through the second vessel, a heat exchanger, a fan operable to flow air past the heat exchanger, and a pump to pump a refrigerant through the fourth conduit, wherein the second thermal transfer material cools the refrigerant flowing through the fourth conduit, the cooled refrigerant configured to flow through the heat exchanger and produce a cooling air that is blown past the heat exchanger by the fan.

9. The system of claim 8, wherein the second cooling loop is configured to continue producing a cooling air when the air conditioning system is turned off.

10. The system of claim 1, further comprising a second cold thermal transfer unit including a third vessel that holds a volume of a third thermal transfer material, and a third conduit that extends through the third thermal transfer material the conduit configured to receive therethrough the expanded refrigerant in gas form that absorbs heat from the third thermal transfer material.

11. An air conditioning system, comprising:
one or more cold thermal storage units, each including a vessel that holds a volume of a thermal transfer material, and a conduit that extends through the thermal transfer material the conduit configured to receive therethrough an expanded refrigerant in gas form that absorbs heat from the thermal transfer material.

12. The system of claim 11, further comprising a hot thermal storage unit including a vessel that holds a volume of a second thermal transfer material, and a conduit that extends through the second thermal transfer material, the conduit configured to receive therethrough a compressed refrigerant in gas form that condenses and transfers heat to the second thermal transfer material.

13. The system of claim 12, further comprising a compressor fluidly connected to and interposed between the one or more cold thermal storage units and the hot thermal storage unit, a heat exchanger for ambient heat rejection fluidly connected to and disposed downstream of the hot thermal storage unit, and a throttling valve fluidly connected to and disposed between the heat exchanger and the one or more cold thermal storage units.

14. The system of claim 12, wherein the hot thermal storage unit is configured to preheat water directed to a water inlet of a water heater.

15. The system of claim 11, wherein the one or more cold thermal storage units are operatively connected to a second cooling loop comprising a third conduit that extends through the vessel, a heat exchanger, a fan operable to flow air past the heat exchanger, and a pump to pump a refrigerant through the third conduit, wherein the thermal transfer material cools the refrigerant flowing through the third conduit, said cooled refrigerant flowing through the heat exchanger and cooling air that is blown past the heat exchanger by the fan.

16. An air conditioning system, comprising:
a hot thermal storage unit including a vessel that holds a volume of a thermal transfer material and a conduit that extends through the thermal transfer material, the conduit configured to receive therethrough a compressed refrigerant in gas form that condenses and transfers heat to the thermal transfer material.

17. The system of claim 16, further comprising one or more cold thermal storage units, each including a second vessel that holds a second volume of a second thermal transfer material and a second conduit that extends through the second thermal transfer material, the second conduit configured to receive therethrough an expanded refrigerant in gas form that absorbs heat from the second thermal transfer material.

18. The system of claim 17, further comprising a compressor fluidly connected to and interposed between the one or more cold thermal storage units and the hot thermal storage unit, a heat exchanger for ambient heat rejection fluidly connected to and disposed downstream of the hot thermal storage unit, and a throttling valve fluidly connected to and disposed between the heat exchanger and the one or more cold thermal storage units.

19. The system of claim 16, further comprising a third conduit configured to extend into the thermal transfer material, the third conduit extending to a water heater, the thermal transfer material configured to heat a liquid flowing through the third conduit.

20. The system of claim 19, wherein the hot thermal storage unit is configured to continue heating the liquid when the air conditioning system is turned off.
